(19) United States
(12) Patent Application Publication
(10) Pub. No.: US 2014/0106330 A1
(43) Pub. Date: Apr. 17, 2014

(54) METHOD AND SYSTEM FOR CREATING SIMULATED HUMAN INTERACTION

(71) Applicant: Bjorn Billhardt, Austin, TX (US)

(72) Inventor: Bjorn Billhardt, Austin, TX (US)

(21) Appl. No.: 13/761,981

(22) Filed: Feb. 7, 2013

Related U.S. Application Data
(60) Provisional application No. 61/714,300, filed on Oct. 16, 2012.

(51) Int. Cl. G09B 7/02

(52) U.S. Cl. CPC G09B 7/02
USPC 434/324

(57) ABSTRACT

In the preferred embodiment, a student is able to talk to a pre-recorded actor displayed on a workstation/computer and have the pre-recorded actor respond directly and precisely to the things that the learner is saying, resulting in a fluid and challenging practice conversation without the use of artificial intelligence. A second user (partner) observes the first user (student) either directly or via videoconference or other means and monitors his interaction with the simulated user/actor in the pre-recorded video displayed on the first user's computer screen. The partner has access to an interface that allows her to direct the simulated user/actor by interpreting the first user's communications and selecting among presented options. These options direct the simulated user/actor to respond to the first user's communication in a convincing and helpful manner.

### CROSS REFERENCE TO RELATED APPLICATIONS

This non-provisional patent application claims priority to U.S. provisional patent application No. 61/714,300 entitled “Method and System for Creating Simulated Human Interaction” filed on Oct. 16, 2012.

### FIELD OF THE DISCLOSURE

The disclosures made herein relate generally to the simulated human interaction industry. The invention discussed herein is in the general classification of a system and method for creating realistic simulated human interaction for educational, training or other purposes.

### BACKGROUND

This section introduces aspects that may be helpful in facilitating a better understanding of the invention. Accordingly, the statements of this section are to be read in this light and are not to be understood as admissions about what is in the prior art or what is not in the prior art.

In human-computer interactions, it is often desirable for the computer to simulate an actual human being. It is imperative for many applications that the human-computer interactions be as convincing and realistic as possible. Most educational programs that teach topics related to soft skills such as communication, human interaction, conflict management, client interaction, customer service and sales involve a component of practice. The art of communication cannot be taught with lectures and power point slides alone because these skills require practice to perfect. Practice exercises are an integral part of every educational program that involves the building of human interaction skills Unfortunately, most practice exercises currently available are not effective in achieving this goal.

Typically, programs teaching soft skills such as communication involve classroom-based role-playing. Students are asked to interact with another student and alternate turns pretending and acting like a specific person involved in a specific situation. A debrief often follows each simulated communication exercise. Most of these role-playing scenarios are ineffective because the learning partner is not a trained actor and the conversation that results sounds fake and unrealistic. Moreover, each partner must extensively prepare to precisely model the designated situation.

Computer based solutions on the market solve some of these problems by using pre-recorded actors to present a situation to which the student must react/respond. Some of these exercises/simulations may even require the student to choose from a menu of options that branch the virtual conversation. The student has to choose from a set of multiple-choice responses to a particular situation and then the exercise/simulation queues up an appropriate video response from the pre-recorded actor. Some of these simulations have hundreds of potential branches/pre-recorded responses from the actor. However, by choosing a path from a menu of options, the student is asked to treat the dialog as an intellectual exercise (i.e. “if I click here, this could happen”). They are not involved in a real conversation where they have to speak to the pre-recorded actor, and they are not truly practicing the art of communication.

A few ambitious simulations have attempted to use artificial intelligence to parse the sentences that a student speaks in response to a pre-recorded video and then determine the appropriate response from a response bank that could include thousands of different responses from the video-based pre-recorded actor. Because artificial intelligence is imperfect, these simulations do not work for most practice based exercises in the real world. The computer rarely understands and interprets the intention of the student from his words.

Some solutions use real live improvisation artists/actors to provide a realistic practice exercise for communication skills This type of solution is for most practical purposes cost prohibitive.

The failure to successfully simulate a human using a computer is well known (e.g. the Turing Test). Artificial intelligence and expert systems are simply not powerful or sophisticated enough to achieve the goal of a convincing interaction. While existing systems allow the pre-preparation of a huge number of sequenced and/or branching potential responses to human input, the computer is unable to correctly understand the nuance and subtlety of human communication, and thus cannot choose correctly among its potential responses.

Hence, it would be beneficial to have a method and system to allow a student to talk to a pre-recorded actor and have the actor respond directly and precisely to the things that the learner is saying, resulting in a fluid and challenging practice conversation without the use of artificial intelligence.

There is a need in the art for an easy to use and inexpensive method and system that allow a student to interact with a pre-recorded, trained actor without utilizing artificial intelligence.

### SUMMARY OF THE DISCLOSURE

The preferred embodiment involves pairing each student at a workstation/computer with a learning partner that logs into the communication simulation using a second workstation/computer connected through the Internet to the same server as the first workstation/computer. The student is presented with a video of an actor stating an issue or asking a question. The student then has to react to the situation by speaking directly to the actor. The computer, of course, does not understand the conversation, but the learning partner, who sits next to the student or who has the ability to see and/or hear the student's response over the Internet interprets the intention of the student and selects from a menu of, for example, thirty to sixty different response choices. This allows the partner to create the closest response match available from the pre-recorded set. After the video response is played, the student has to respond to the response and the conversation may continue, usually for five to fifteen cycles of fluid back-and-forth conversation. A skilled facilitator can then debrief the student's responses, if appropriate.

In the proposed invention, the student/user interacts with a simulated human (actor in the video). A second user (the “partner”) observes the student/user (either directly or via videoconference or other means) and monitors his interaction with the simulated human. The second user/partner has access to an interface that allows him to direct the simulated human by interpreting the students/user's communications (electronic, spoken or visual) and selecting among presented options. These options direct the simulated human to respond to the user's communication in a convincing and helpful way.

In the preferred embodiment, a student is able to talk to a pre-recorded actor and have the actor respond directly and precisely to the things that the student is saying, resulting in a fluid and challenging practice conversation without the use of artificial intelligence. This fluid and realistic conversation allows for realistic scenarios to be presented to the student and asks the student to react to and interact with the pre-recorded actor in a way that creates a realistic practice environment, branching into discussion topics of the student's choosing. This permits meaningful communication exercises in all different types of circumstances (sales, customer service, management and verbal communications skills).

Under some applications embodiments of the invention may provide for a first workstation/computer associated with a student and a second workstation/computer associated with a learning partner that logs into the communication simulation using the second workstation/computer connected through the Internet to the same server as the first workstation/computer.

Under some applications embodiments of the invention allow for a new or experienced manager to talk to a pre-recorded actor pretending to be an employee, customer, or partner and have the actor respond directly and precisely to the manager's statement or question, resulting in a fluid and challenging practice conversation for managers, without the use of artificial intelligence.

Under some applications embodiments of the invention allow for a student to talk to a pre-recorded actor and have the actor respond directly and precisely to the student's words, resulting in a fluid and challenging practice conversation, without the use of artificial intelligence.

Under some applications, embodiments of the invention allow for a relatively easy to use system in which a student talks to a pre-recorded actor and the actor responds directly and precisely to the student's words, resulting in a fluid and challenging practice conversation, without the use of artificial intelligence.

Under some applications, embodiments of the invention may provide a reliable to use system in which a student talks to a pre-recorded actor and the actor responds directly and precisely to the student's words, resulting in a fluid and challenging practice conversation, without the use of artificial intelligence.

Under some applications, embodiments of the invention may provide an inexpensive system in which a student talks to a pre-recorded actor and the actor responds directly and precisely to the student's words, resulting in a fluid and challenging practice conversation, without the use of artificial intelligence.

### BRIEF DESCRIPTION OF THE DRAWINGS

Some embodiments of apparatus and/or methods of the present invention are now described, by way of example only, and with reference to the accompanying drawings, in which:

FIG. 1 depicts the system of the preferred embodiment.

FIG. 2 depicts the preferred embodiment of the device/server containing the pre-recorded responses for use in the system of the preferred embodiment.

FIG. 3 depicts the preferred methodology implemented by the device/server of the preferred embodiment.

### DETAILED DESCRIPTION OF THE DRAWINGS

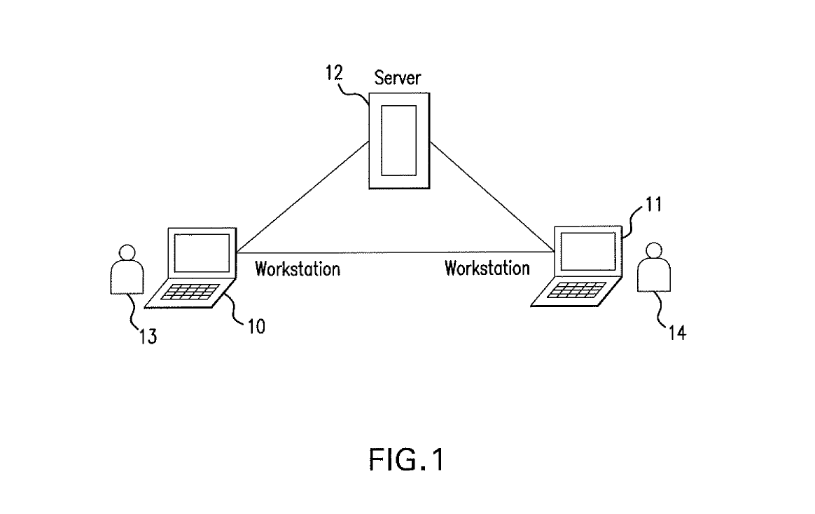

FIG. 1 depicts the system of the preferred embodiment. A user/student 13 associated with a workstation/computer 10 can select a pre-recorded video of an actor presenting a specific situation or asking a question or creating some other scenario requiring a response from the user/student 13 through a user interface on the workstation/computer 10. The pre-recorded video can be streamed or downloaded to the workstation 10 from a server 12 containing the various pre-recorded videos. In response to the pre-recorded video selected, the user/student 13 can audibly respond to the video. This audible response can be heard and potentially even seen by a second user/partner 14 listening and/or watching the user/student 13 via video conference on a workstation/computer 11 associated with the second user/partner 14. In the case of a video conference, the first workstation/computer would have a video camera to transmit images of the user/student 13.

In certain alternative embodiments, the second user/partner 14 selects the pre-recorded video that initially presents a specific situation or asks a question or creates some other scenario requiring a response from the user/student 13 from the second workstation/computer 11. A scenario requiring a response could involve, for example, an interview question, a conversational sentence in a foreign language or a portion of a script being performed by an actor.

Based on the user/partner's understanding of the visible and audible response of the user/student 13 to the pre-recorded video, the user/partner 14 can select via a user interface from a menu of options on the user's/partner's workstation/computer 11 to provide a second pre-recorded video of an actor to simulate an appropriate reply to the user/student's response to the original pre-recorded video. The menu of options lists all of the potential pre-recorded videos available in the database for a given situation. The second pre-recorded video would traditionally also be contained on the same server 12 as the original pre-recorded video and could be streamed or downloaded to the computer/workstation 10 associated with the user/student 13. This process can be repeated as desired to simulate a conversation or interaction with an actual human being. The user/partner 14 or another individual could then critique the user/student's performance when the conversation is complete. This critique could come in the form or messaging, e-mailing or voice data sent from the second workstation 11 to the first workstation 10 or from a third workstation of another individual listening and/or observing the user 13 located at the first computer/workstation 10.

By way of example, the user/student 13 associated with computer/workstation 10 could decide he would like to practice for a job interview. Using his computer/workstation 10, he could select job interview as the situation for which he would like to practice his communication skills He could then select or have the second user/partner 14 select a pre-recorded video from the menu of options for that situation to begin the conversation. The first video selected and sent to the computer/workstation 10 could be a video of an actor asking the user/student 13, for example, “what is your name?”. The user/student 13 could respond with “John Doe” and the second user/partner 14, observing this response via video conference, could then select the next video to be sent from the server 12 to the workstation 10. For example, the second user/partner 14 may select the next pre-recorded video that involves the actor asking, “what position are you applying for in this organization?” from the menu/database of videos contained at the server 12 for the job interview situation. Again, the second user/partner 14 could observe the response of the first user/student 10 and make an appropriate selection from the database of pre-recorded videos to continue the interview process.

By way of further example, the user/student 13 associated with computer/workstation 10 could decide he would like to practice a difficult manager/employee conversation. Using his computer/workstation 10, he could select the situation for which he would like to practice his communication skills The situation also could be selected by the computer based on prior interactions with a related simulation of the workplace. The user/student 13 could then select or have the second user/partner 14 select a pre-recorded video from the menu of options for that situation to begin the conversation. The first video selected and sent to the computer/workstation 10 could be a video of an actor asking the user/student 13, for example, “Can I have an additional week of vacation time this year based on my performance?”. The user/student 13 could respond in any way he deems appropriate and the second user/partner 14, observing this response via video conference, on the phone, or in person, could then select the next video to be sent from the server 12 to the workstation 10 based on the most appropriate interpretation of the response of the user/student 13. For example, the second user/partner 14 may select the next pre-recorded video based on a set of key words and/or phrases associated with the pre-recorded videos after interpreting the user/student's response. If the user/student 13 says, “you did not perform well this year” in response to the first pre-recorded video then the second user/partner 14 may select a second pre-recorded video that may be labeled “No—based on performance” or “You did not perform well this year”. This second pre-recorded video may involve the actor stating, “But I thought I did well!”. Again, the second user/partner 14 could observe the response of the first user/student 10 to this second pre-recorded video and make an appropriate selection from the database of pre-recorded videos to continue the management conversation.

Obviously, it would also be possible to have the videos sent to the second computer/workstation 11 as well as the first computer/workstation 10 to allow the second user/partner 14 to view the video of the actor should this be determined to be beneficial in a given situation.

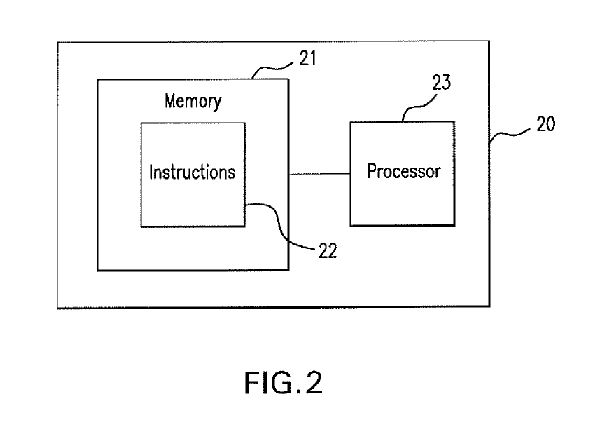

FIG. 2 depicts the preferred embodiment of the device/server containing the pre-recorded responses for use in the system of the preferred embodiment. The server 20 contains a memory 21 containing a set of instructions 22 and a processor 23 operatively connected to the memory for processing the set of instructions. The set of instructions include instructions for: receiving a request for a first pre-recorded video stored at the server 20 from one of a first workstation operated by a first user and a second workstation operated by a second user; locating the first pre-recorded video stored at the server 20; sending the first pre-recorded video from the server 20 to the first workstation connected to the server 20; receiving a request for a second pre-recorded video stored at the server 20 from a second workstation operated by a second user and connected to the server 20 wherein the second user selects the second pre-recorded video based on observing the first user's reaction to the first pre-recorded video; locating the second pre-recorded video stored at the server 20; sending the second pre-recorded video form the server 20 to the first workstation.

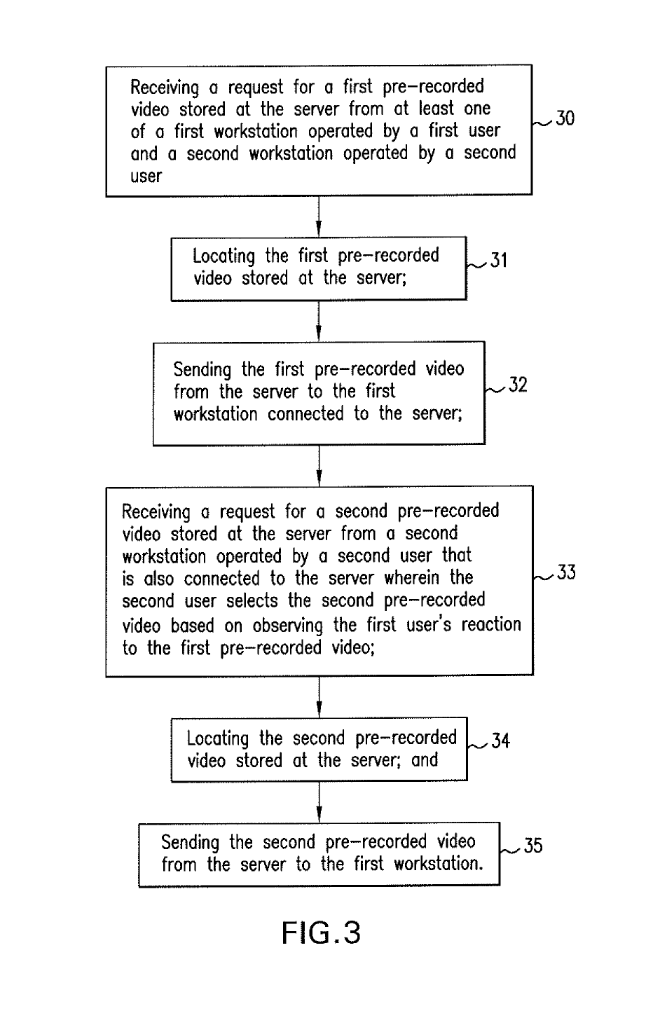

FIG. 3 depicts the preferred methodology implemented by the device/server of the preferred embodiment. The methodology includes: receiving a request for a first pre-recorded video stored at the server from one of a first workstation operated by a first user and a second workstation operated by a second user 30; locating the first pre-recorded video stored at the server 31; sending the first pre-recorded video from the server to the first workstation connected to the server 32; receiving a request for a second pre-recorded video stored at the server from a second workstation operated by a second user that is also connected to the server wherein the second user selects the second pre-recorded video based on observing the first user's reaction to the first pre-recorded video 33; locating the second pre-recorded video stored at the server 34; sending the second pre-recorded video form the server to the first workstation 35.

A person of skill in the art would readily recognize that the order of the steps of the above-described method is not necessarily critical and could be altered without departing from the spirit of the invention.

One skilled in the art would further understand that observing the first user's reaction to the pre-recorded videos may be done either in person or via videoconference or other well known technology that permits the second user to hear or see the first user.

One skilled in the art would also understand that different servers could be used to store the various pre-recorded videos and that, depending on the geographic location of the first user and the second user, the first user and second user could utilize the same workstation for viewing and selecting videos.

It should further be understood that the methodology described herein could begin with the second user selecting the first pre-recorded video and can continue indefinitely with the second user continuing to select pre-recorded videos to display for the first user based on the reaction of the first user to the immediately preceding pre-recorded video.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A system for creating simulated human interaction comprising:
(a) a first workstation associated with a first user;
(b) a server containing a first pre-recorded video selected by at least one of the first user and a second user wherein the pre-recorded video presents a scenario requiring a response from the first user and wherein the first pre-recorded video is sent to the first workstation from the server; and
(c) a second workstation associated with the second user wherein the second user can hear the response to the first pre-recorded video from the first user transmitted from the first workstation to the second workstation.

2. The system of claim 1 wherein the second user views the response of the first user to the first pre-recorded video and the video images of the response of the first user to the first pre-recorded video are transmitted from the first computer having a video camera to the second computer.

3. The system of claim 1 wherein an actor pre-records the scenario in the first pre-recorded video and wherein the scenario is one of: an interview question, a conversational sentence in a foreign language, and a portion of a script being performed by an actor.

4. The system of claim 1 wherein the first user selects the first pre-recorded video through use of a user interface on the first workstation.

5. The system of claim 1 wherein the second user selects the first pre-recorded video through the use of a user interface on the second workstation.

6. The system of claim 1 wherein the first pre-recorded video is sent by one of streaming and downloading from the server to the first workstation.

7. The system of claim 1 wherein the second user selects a second pre-recorded video via a user interface on the second workstation based on the second user's interpretation of the response of the first user to the first pre-recorded video and the second pre-recorded video is sent to the first workstation.

8. The system of claim 7 wherein the second pre-recorded video is of one of the actor and a second actor conveying an appropriate reply to the first user's response to the first pre-recorded video.

9. The system of claim 8 wherein the second pre-recorded video is contained in the server along with the first pre-recorded video.

10. The system of claim 7 wherein the second pre-recorded video is one of streamed and downloaded to the first workstation.

11. The system of claim 7 wherein the second user critiques the first user's performance via one of messaging, e-mail and voice data sent from the second workstation to the first workstation.

12. The system of claim 7 further comprising a third workstation associated with a third user who is listening to the first user and has the capability to send a critique of the performance of the first user from the third workstation to the first workstation.

13. A device comprising:
(a) a memory containing a set of instructions;
(b) a processor operatively connected to the memory for processing the set of instructions which include instructions for: receiving a request for a first pre-recorded video stored at the device from at least one of a first workstation operated by a first user and a second workstation operated by a second user; locating the first pre-recorded video stored at the device; sending the first pre-recorded video from the device to the first workstation connected to the device; and receiving a request for a second pre-recorded video stored at the device from the second workstation operated by the second user and connected to the device wherein the second user selects the second pre-recorded video based on observing a response of the first user to the first pre-recorded video.

14. The device of claim 13 wherein the set of instructions further include instructions for locating the second pre-recorded video stored at the device.

15. The device of claim 14 wherein the set of instructions further include instructions for sending the second pre-recorded video from the device to the first workstation.

16. A method of creating simulated human interaction comprising the steps of:
(a) receiving a request for a first pre-recorded video stored at a server from one of a first workstation operated by a first user and a second workstation operated by a second user;
(b) locating the first pre-recorded video stored at the server; and
(c) sending the first pre-recorded video from the server to the first workstation connected to the server; and
(d) receiving a request for a second pre-recorded video stored at the server from a second workstation operated by a second user that is also connected to the server wherein the second user selects the second pre-recorded video based on observing a response of the first user to the first pre-recorded video.

17. The method of creating simulated human interaction of claim 16 further comprising the step of: locating the second pre-recorded video stored at the server.

18. The method of creating simulated human interaction of claim 17 further comprising the step of: sending the second pre-recorded video form the server to the first workstation.
